(19) United States
(12) Patent Application Publication
(10) Pub. No.: US 2018/0110592 A1
(43) Pub. Date: Apr. 26, 2018

(54) SAFETY RELEASE ORTHODONTIC SKELETAL EXPANDER USING MINI IMPLANTS

(71) Applicant: Wael Kanaan, Pearland, TX (US)

(72) Inventor: Wael Kanaan, Pearland, TX (US)

(21) Appl. No.: 15/333,531

(22) Filed: Oct. 25, 2016

(51) Int. Cl. A61C 7/10

(52) U.S. Cl. CPC A61C 7/10

(57) ABSTRACT

An orthodontic skeletal expander attached to the jaw bone with mini implants needs a safety mechanism to allow easy removal in emergency cases. The safety release orthodontic skeletal expander includes two bodies with two incomplete holes in each body. The incomplete holes will not only provide enough surface to guide and hold the mini implants, but also enough open area to remove the expander if needed. Each incomplete hole has two safety-release wings opposite to each other that can bend easily under enough pressure allowing the emergency removal of the expander and/or removing the bent mini-implant(s). The four incomplete holes have two different inclinations to allow the mini-implants either to be placed parallel to each other or in a V-shaped configuration based on the palate shape of the patient.

### TECHNICAL FIELD

This invention relates to orthodontic appliances and, more particularly, to expanders that expand both dental and skeletal arches by opening the midpalatal suture.

### BACKGROUND

Traditionally, different teeth-supported expanders have been proposed by different inventors to expand both the dental and skeletal components of the upper jaw when needed. Various patents such as, U.S. Pat. Nos. 3,835,540, 4,347,054, 4,482,318 and 5,281,133, show these devices with different designs and sometimes are called Rapid Palatal Expanders “RPE”.

On the other hand, other inventors have sought to achieve bone-supported expanders by attaching the expander directly to the bone either by plates such as Jeffrey A. Ascherman U.S. Pat. No. 6,238,745 or by eyelets such as Michael O. Williams U.S. Pat. No. 8,113,826.

In 2014, won moon filed his patent application for a modified rapid palatal expander where he implemented four complete holes 112 to the sides of the expander body #100. These complete holes were designed to allow the expander to be secured to the palatal bone via mini implants. Thus, expansion forces will be delivered more directly to the bone through the mini-implants. He was granted U.S. Pat. No. 9,351,810 B2 and named his device Maxillary Skeletal Expander.

FIG. 1 is a view illustrating won moon Maxillary Skeletal Expander. The related expander is fixed vertically to bone via four mini implants S and includes a pair of bodies 100, two arms 200 fixed to each body 100, two holes 112 on the side of each body, two guiding rails 400 and one extending screw 300 with a key hole in it 500. When a key is inserted into the key hole 500 to rotate the extending screw, the bodies 100 with the four mini implants S will move apart creating a space between the two bodies and separating the midpalatal suture.

However, the current Maxillary skeletal expander has 3 shortfalls.
1. In some cases, the bone and sutures are very tight causing the implant(s) to get bend and thus stuck in the hole(s) of the expander. In other cases, the soft tissue around the expander can get inflamed and swollen which will require immediate attention by removing the expander with the mini implants. This will make the removal process of the expander and the bent implant(s) very difficult and almost impossible. If the area is infected and the expander cannot be removed, this might pose a serious health consequence to the patient.
2. Another disadvantage of the current Maxillary skeletal expander is that the holes 110 are located on the side of the bodies making the expander wider. This, in fact, makes it extremely difficult to place the expander close to the palate when the patient's maxilla is very small.
3. Also, the prior art design does not allow to place the mini-implant(s) perpendicular to the bone in narrow V-shaped palate and, thus, distributing unfavorable forces to the palatine bone.

### SUMMARY

A modified Maxillary Skeletal expander has been developed to remedy the shortcomings of the prior art. The Maxillary Skeletal Expander has four incomplete 2 holes with a 225-degree circle. These incomplete holes will allow the body of the expander to be easily disengaged from the implant(s) in a case of a failure and will provide enough surface to guide the mini implants while insertion.

Furthermore, in the new design, the incomplete holes are not located to the side of the body, but on the same line of arms within the body of the expander. This will allow the expander to be smaller to fit a tight Maxilla easier.

To address the problem of narrow V-shaped palates, the incomplete holes are designed either as 90-degree angle 2 for flat palates or 110-degree angle 2T for V-shaped palates.

### BRIEF DESCRIPTION OF THE DRAWINGS

FIG. 1 (prior art) is an exploded perspective view illustrating won moon Maxillary Skeletal Expander using mini-implants

FIG. 2 is a top view of the Orthodontic Skeletal Expander of the present invention

FIG. 3 is an isometric view similar to FIG. 2 for the Orthodontic Skeletal expander of the present invention with two mini-implants in place.

FIG. 4 is a tilted side view of the body presenting its elliptical shape in a cross section

FIG. 5 is a top view similar to that of FIG. 2, but with focus on the incomplete circular holes

FIG. 6 is a side view for the body with 110-degree inclination of the incomplete holes

FIG. 7 is sectional view of the present invention expander with the 90-degree design

FIG. 8 is sectional view of the present invention expander with the 110-degree design

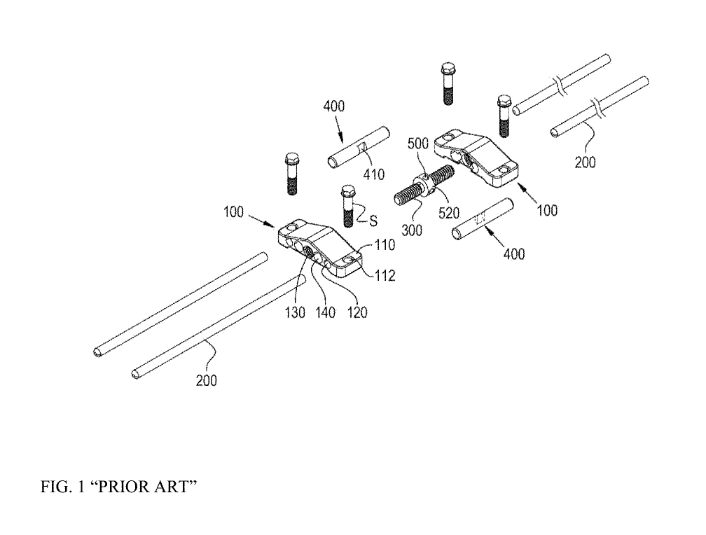

### DETAILED DESCRIPTION OF THE PREFERRED EMBODIMENT

In the subsequent part of this document, an implant-supported orthodontic skeletal expander with safety release according to an embodiment of the current invention will be described in detail to enable any person skilled in the art or science of dentistry/orthodontics to make and use.

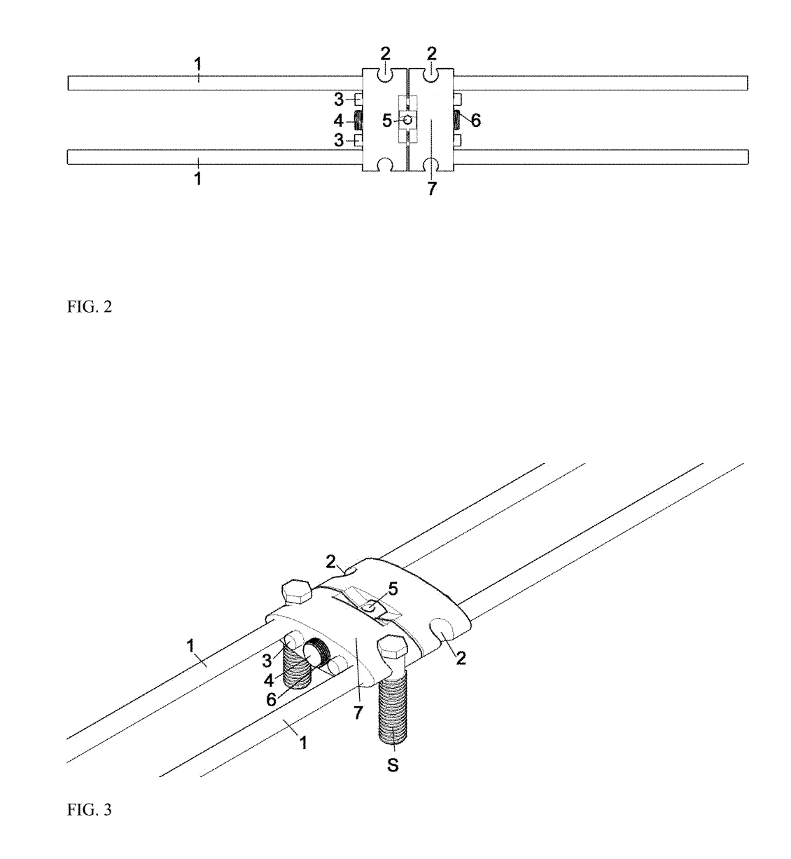

Referring first to FIGS. 2 and 3, an orthodontic skeletal expander with safety release constructed in accordance with the preferences of this invention includes five main components; four arms 1, two guiding rails 3, one central screw 4, two main bodies 7 with incomplete holes 2 to accept the mini implant(s) S, and two rubber gaskets 6.

The arms 1 are soldered to the main body 7 from one end and attached to the teeth from the other end if desired. When attached to teeth, the arms 1 must be adjusted to fit the patient palate as needed. These arms, also, could be cut partially or completely if pure bone-loaded maxillary skeletal expansion is desired.

The two guiding rails 3 are positioned parallel into each side tunnel of the body to prevent any rotation of the bodies while expanding and to provide a smooth sliding surface for the bodies to move freely from each other. This will maintain the two bodies in a parallel position while expanding.

The central screw 4 has two opposite threaded portion on each side and two perpendicular holes 5 located at the central body of the screw. One side the threads are in a clock-wise direction and on the other side the threads are in a counter clock-wise direction. This allows the two bodies to move apart if the screw is turned backward or the bodies will move toward each other if the screw is turned forward. The screw 4 diameter is very close to the diameter of the threaded central tunnel in the body leaving a small space for the gasket 6 to fill in. The four central holes 5 will provide the space for the rotating key (not shown) to rotate the screw forward or backward.

Each body 7 has three parallel tunnels, two incomplete holes 2 and two arms 1 soldered to it. The three tunnels are composed of; a central tunnel with opposite threads to match the extending screw 4 threads and two smooth tunnels on the side of the central tunnel for the guiding rails 3. The two incomplete holes 2 FIG. 5 are two open incomplete circles facing outside of the main body with the open part of the circle facing the lateral side of the main body. These incomplete holes will provide the means to fix the expander to the bone using the mini implants and also provide a guiding surface to facilitate implant insertion. They are located on each side of the body FIG. 3 and are designed with a 225-degree interior angle 2B forming an incomplete circle in the body and an open area of 135-degree exterior angle facing outside the body. The 225-degree part FIG. 5 will provide enough surface to guide the mini-implants during insertion and, also, enough surface to mechanically hold the expander to the mini-implant during active expansion. On the other hand, the 135-degree open area will provide enough area to tweak the expander off the mini-implant if needed. The two thin wings 2A FIG. 5 are part of the incomplete circle positioned on the opposite location of the open incomplete circle where the incomplete circle meets the outside border of the body. These two wings will act as safety release wings as they will bend easily under enough pressure allowing the emergency removal of the expander and/or removing the bent mini-implant(s). The interior angle of 225 degrees is measured from the tip of one wing to the tip of the opposite wing inside the incomplete hole.

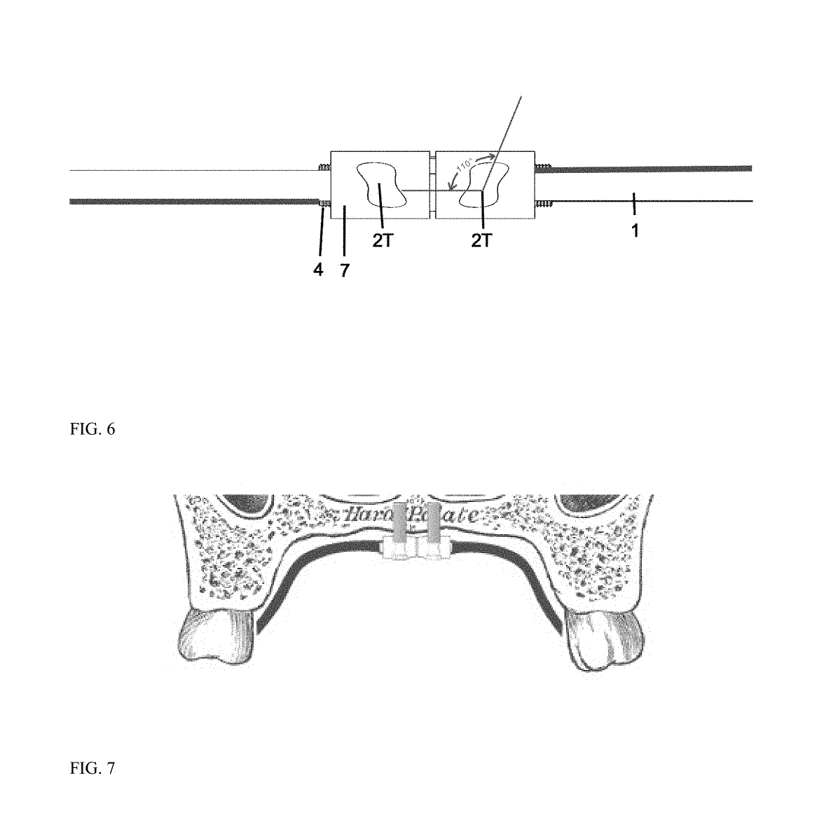

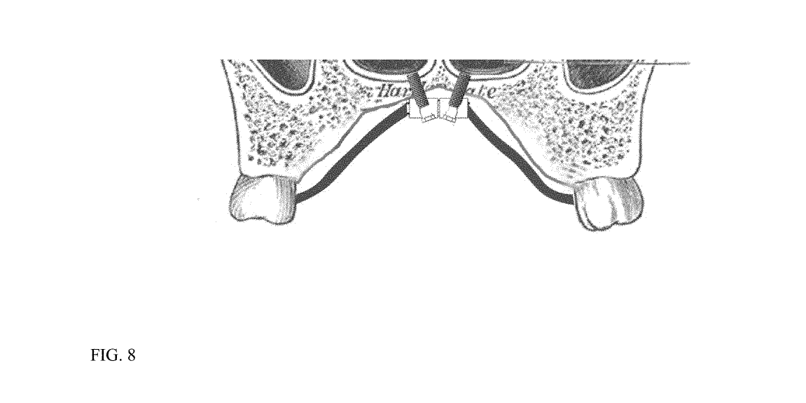

From a side view FIG. 6, the long axis of the incomplete holes may be either 90 degree or 110 degrees 2T relative to the long axis of the guiding rails. The 90-degree will allow a parallel placement of the 4 mini implants while the 110-degree will allow a V-shape placement of the mini implants. This variation will provide a better option for narrow palates where the palate looks like a V-shape FIG. 8. In this case, the 110-degree inclination will provide an extra 20 degree of implant inclination in order to be perpendicular to the palatine bone allowing proper distribution of forces during expansion and minimizing the chance of implant(s) failure.

FIG. 7 is a sectional view illustrating an example of application of the orthodontic skeletal expander with a 90-degree incomplete holes using parallel mini implants according to an embodiment of the present invention to a flat upper palate of a patient.

FIG. 8 is a sectional view illustrating an example of application of the orthodontic skeletal expander with a 110-degree incomplete holes using mini implants according to an embodiment of the present invention to a V-shape upper palate of a patient.

The incomplete holes 2 might be other than 225 degrees: they might range from 190 degrees to 270 degrees based on the type of mini implant used with the expander.

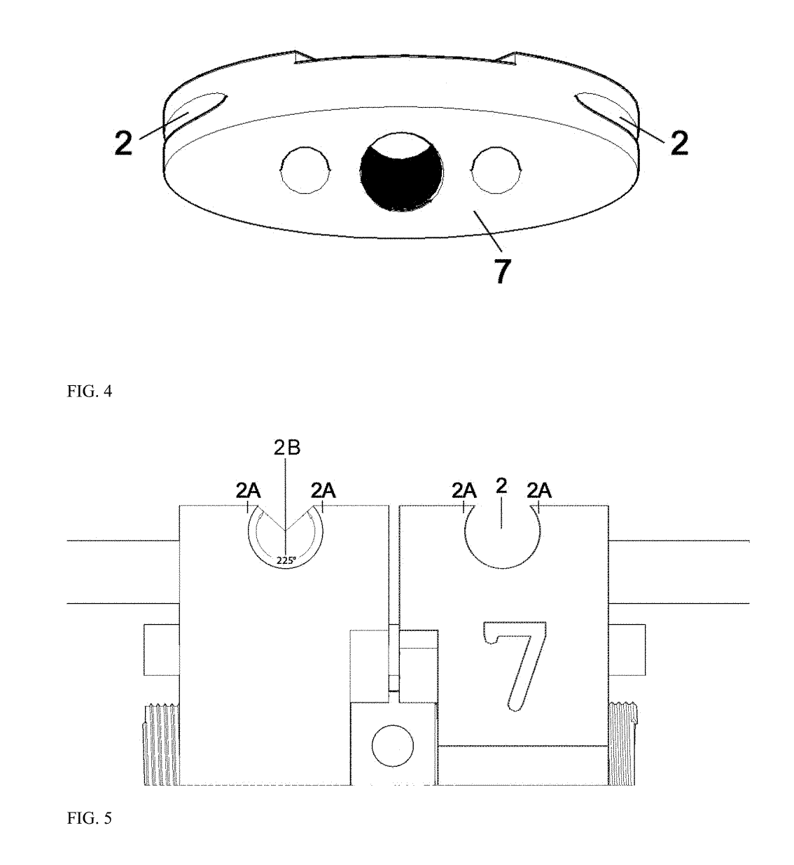

The present invention has a body with an elliptical cross section FIG. 4 making the sides of the expander thinner than the center. This body shape will help the safety release wings to be thinner at end of the incomplete holes facilitating the function of the safety release wings to remove the expander and/or the mini-implant in a case of an emergency. The body has a thickness of 2.5 mm.

To prevent the central screw from rotating backward, two rubber gaskets 6 are used to provide extra friction and hold the screw in place.

With the above detailed descriptions, any person of ordinary skill in dentistry/orthodontics could make and use the invention without extensive experimentation.

What is claimed is:

1. (canceled)

2. (canceled)

3. (canceled)

4. In a skeletal expander using mini screws employed to expand the maxillary bone, including two bodies, a central screw with a hole, two guiding rails and two pairs of arms, the improvement comprising:
a. Two incomplete holes with guiding surface on each side of the body. The incomplete hole is an open incomplete circle facing outside the main body with the open face located on the lateral side of each body. The guiding surface of the incomplete hole will help to insert the mini-implant easily and accurately.
b. Two safety release wings located on the outside of each incomplete hole with thin walls to bend easily under enough pressure allowing the emergency removal of the expander and/or removing the bent mini-implant(s).

5. The skeletal expander defined in claim 4, where the incomplete hole has an interior inclusive angle that ranges from 190 degrees to 270 degrees as measured from the tip of one safety-release wing to the opposite tip.

6. The skeletal expander of claim 4, wherein the incomplete holes' inclination ranges from 90 degrees to 110 degrees allowing the mini implants to be placed parallel to each other or in a V-shape configuration. The inclination angle is measured between the long axis of the incomplete hole and the long axis of the guiding rails as viewed from the side.
